(19) United States
(12) Patent Application Publication
(10) Pub. No.: US 2018/0154736 A1
(43) Pub. Date: Jun. 7, 2018

(54) COMPONENT AND METHOD FOR CONNECTING COMPONENTS

(71) Applicant: Odenwald-Chemie GmbH, Schönau (DE)

(72) Inventors: Hans-Peter Augele, Heidelberg (DE); Michael Kastner, Wolfsburg (DE); Michael Feist, Hirschberg (DE); Torsten Schwammberger, Binau (DE); Dominik Hotz, Schönau (DE)

(21) Appl. No.: 15/735,038

(22) PCT Filed: Jun. 7, 2016
(86) PCT No.: PCT/EP2016/062866

§ 371 Date: Dec. 8, 2017

(30) Foreign Application Priority Data
Jun. 9, 2015 (DE) 10 2015 109 090.2

(51) Int. Cl. B60H 1/00; F16L 37/092

(52) U.S. Cl. CPC B60H 1/00564; F16L 37/092

(57) ABSTRACT

A component for conducting a gas such as air, having a tubular main body and a connection element for connecting in a form-fitting manner to a further component, the connection element configured to be integral with the tubular main body, wherein the tubular main body and the connection element are configured from an elastic material, and wherein the connection element is configured to be formed by the tubular main body.

### BACKGROUND OF THE INVENTION

The invention relates to a component, in particular an air-conducting component, and to a method for connecting components, in particular air-conducting components.

Air conduits, or air ducts, respectively, in vehicles are equipped with assembly elements in order to be linked to further components, for example to a further air duct, to a distributor housing, or to a pipe connector. For example, injection-molded plastic parts, cable ties, adhesive-mounted foam parts, or other separate parts, are used as assembly elements. The assembly elements often have to be adapted to the air ducts in a manner that is complex in terms of production technology, this causing additional costs. Further costs and an additional effort arise on account of seals to be inserted. Moreover, the known assembly elements often have the disadvantage that the technician is provided with insufficient feedback as to whether the air conduit has been connected adequately to the add-on part, or whether a permanent firm fit is guaranteed, respectively. Therefore, it is difficult for an adequately tight firm fit to be reliably guaranteed or ensured, respectively.

The invention is based on the object of providing a component, in particular an air-conducting component, which can be connected to a further component, in particular to a further air-conducting component, in a manner that is simple, reliable, and as far as possible cost-effective. The invention is furthermore based on the objective of specifying a simple, reliable, and as far as possible cost-effective method for connecting components, in particular air-conducting components.

### SUMMARY OF THE INVENTION

The component according to the invention comprises a tubular main body, in particular for conducting gas, preferably air, and a connection element for connecting in a form-fitting manner to a further (second) component, said connection element being created and/or capable of being created integrally (as one piece) with the tubular main body.

The component according to the invention is in particular a component for guiding an element, in particular a gas, in particular air. The component is preferably an air-conducting component, an air conduit, or an air duct, in particular for a heating, ventilation and/or air-conditioning installation of a vehicle. In general, an air-conducting component is to be understood as a component which is suitable and provided for conducting or guiding, respectively, air from a first region to a second region. Apart from a pipe, this herein can also be a distributor housing, an intake duct, a silencer, a pipe connector, or else another component that is suitable for guiding air. In principle, however, the invention can also be applied to other components for guiding an element, for example to a cable conduit or a cable duct, for example.

A basic concept of the invention in the case of such a component for guiding an element is for a connection element (a connection portion) to be created, in particular formed, integrally with the tubular main body such that separate assembly elements can be dispensed with. The connection element and at least part of the tubular main body are thus formed on a common piece or part, respectively, or interconnected in a form-fitting manner. The connection element is thus expediently created integrally or unreleasably, respectively, with the tubular main body, on account of which the reliability of linking the component to a further component is enhanced. Moreover, additional costs on account of additional components (assembly elements) are dispensed with.

In principle, the air-guiding component according to the invention can be an arbitrary component which is provided for guiding air, in particular in a heating, ventilation and/or air-conditioning installation of a vehicle. For example, this can also be a so-called end piece, for example an adapter frame, a push-fit part, a distributor housing, or a contact pressure part, which is to be linked to an air duct. Components of this type likewise have a tubular main body for guiding gas or air, respectively. The invention enables in particular the connection of foam ducts or of ducts from other preferably elastic materials to one another so as to form nozzles and connector pieces.

The connection element, or the connection region, respectively, is preferably disposed on a circumferential face of the tubular main body, in particular on an internal circumferential face or skin surface and/or on an external circumferential face or skin surface. For a tight or leakage-free connection, respectively, to the adjacent component it is advantageously provided that the connection element is suitable for performing an elastic movement in a radial direction of the component so as to press against the component to be linked in the radial direction (toward the inside or the outside). To this end, the connection element is preferably created from an elastic material. The connection element, or the connection region (a portion of the component/air guide that is turned over), respectively, preferably offers a retention function.

In one preferred design embodiment of the invention it is provided that the connection element is produced and/or is capable of being produced by forming the tubular main body. The connection element is thus created or formed in that the tubular main body in an initial or basic state is formed. The tubular main body in the initial or basic state (prior to forming) can also be referred to as a tubular initial body. By forming, the tubular main body and the connection element that is created integrally with the former is produced or formed, respectively, from said tubular initial body. In order for the connection element to be produced, it is provided in particular for an axial end region of the tubular initial body, or of the main body, respectively, to be formed.

It is preferable for the tubular initial body (main body in an initial or basic state) in an axial end region to have a forming portion that is capable of being manually formed and is capable of being formed to create the connection element. The tubular initial body is thus capable of being formed in such a manner that the connection element can be created by the forming. It is provided in a first variant that the forming portion for creating the connection element is capable of being formed or bent in an outward manner. On account thereof, the connection element is crated on an external circumferential face, or on an external circumferential region, respectively. The component according to the invention can thus be plug-fitted into a further component. In order for a form-fitting connection to be created, the connection element engages with an engagement element of the second component. It is provided in a second variant that the forming portion for creating the connection element is capable of being formed or bent in an inward manner. This enables the second component to be plug-fitted into the component according to the invention in such a manner that a form-fitting connection is capable of being produced by an engagement of the connection element in an engagement region of the second component. In principle, it can also be provided that the tubular initial body, or the forming portion, respectively, is capable of being selectively formed in an outward or inward manner. Connecting the two components is thus preferably performed by a plug-fit in the axial direction.

In a further preferred embodiment it is provided that the connection element is produced and/or capable of being produced by turning over an axial end region, or end portion, of the tubular main body, or of the initial body, respectively. Turning over is to be understood in particular as forming or bending the axial end of the tubular initial body in a rearward or opposite direction, that is to say by more than 90°, preferably at least 135°. It is provided in particular for the axial end region of the tubular main body or initial body, respectively, to be folded or bent, respectively, in the direction of the opposite axial end. The tubular initial body is preferably turned over along a defined forming line. Turning over/folding back/folding can be performed in an outward and/or inward manner.

A good sealing effect can be achieved in that the tubular initial body, or the tubular main body, respectively, having the connection element is created from an elastic material. The elastic material enables radial sealing, in particular in a manner analogous to that of a radial shaft sealing ring. In a further preferred design embodiment it is provided that the connection element is connected to the tubular main body in an elastic-resilient manner. An articulation or a hinge which guarantees an elastic-resilient movement of the connection element relative to the tubular main body is thus preferably created between the tubular main body and the connection element.

According to the invention it is particularly preferable for the tubular main body, and correspondingly also for the connection element that is created integrally with the former, to be created from a foamed material. In one exemplary embodiment, the component according to the invention is an air guide, or an air duct, respectively, from a foam film, or is a foam film air duct, respectively. This is preferably a polyolefin foam material (PO foam material), for example PE foam material or PP foam material. The foamed material is particularly suitable for in particular manual forming, in particular at the assembly site, in order for the connection element to be produced. Moreover, good sealing can be achieved by virtue of the material properties. Finally, the foamed material is particularly light and acts in a noise-silencing and/or noise-damping manner. This is preferably a closed cell-foam material. The density is preferably in the range from 70 to 110 g/dm³, in particular 80 to 100 g/dm³, preferably of approximately 90 g/dm³.

In order for air-guiding components to be connected, it is preferable for the connection element to be suitable for establishing a sealed state in relation to the further (second) component. A sealed state herein is to be understood in particular to be a state which provides adequate sealing (in particular a tightness according to the testing rules of automotive manufacturers, for example the TL and VW testing requirements) for an air-guiding component of a vehicle heating, vehicle ventilation, and/or vehicle air-conditioning.

In order for the forming to be facilitated, it is preferable according to the invention that the tubular main body in a basic state (thus the tubular initial body) has an at least partially encircling weakening, in particular a material weakening, along which the tubular main body, or initial body, respectively, is capable of being formed in order for the connection element to be created. In particular, the tubular main body can have a transition region which creates a hinge along which the tubular main body is capable of being formed in order for the connection element to be created. The material weakening can have in particular a perforation and/or a wall thickness reduction. The material weakening is preferably created by at least one in particular encircling or interrupted cut, in particular at least one incision and/or clean cut, a serrated knife cut, or a serrated material thinning, respectively, and/or by a material thinning or a wall thickness reduction, respectively, and/or by punched features and/or cleanly punched out features, in particular in order for a perforation to be created in particular in the circumferential direction, and/or by a weakening caused by thermal means. A weakening caused by thermal means can preferably be achieved by laser machining, machining by a hot wire or a hot mandrel (similar to a soldering iron). The weakening can also be created by a bellows. On account of the weakening, the tubular initial body is subdivided into the tubular main body and a forming portion. The weakening is preferably located in an end region of the tubular initial body. The spacing of the weakening from the axial end is preferably at maximum 50 mm, particularly preferably at maximum 15 mm, or at maximum 10 mm. Said spacing is preferably at least 5 mm, in particular at least 10 mm. It is provided in particular that the spacing is between 5 and 15 mm. The spacing of the weakening from the axial end defines the axial length of the forming portion, or of the connection element to be created, respectively. In other words, the axial length of the forming portion is preferably 5 and 40 mm. The longer the portion (forming portion, or connection element, respectively), the more reliably the terminal position is maintained. The weakening preferably creates a transition portion between the main body and the forming portion or the connection element, respectively. A bellows which creates a flexible moving element can be provided as a transition portion, for example.

The length of the forming portion, or the spacing of the material weakening from the axial end of the tubular main body (in the non-formed basic state) is preferably at least two times, in particular at least three times, the material thickness of the tubular main body. Furthermore preferably, the length of the forming portion, or the spacing of the material weakening from the axial end of the tubular main body (in the non-formed state) is at maximum 10 times, in particular at maximum six times, the material thickness of the tubular main body.

The tubular main body (or the air duct, respectively) can be configured as a monocoque body. Alternatively, the tubular main body (or the air duct, respectively) is preferably created from at least two interconnected shells, preferably clamshells, or has at least two shells/clamshells, respectively. The clamshells can be produced by vacuum forming, embossing, by the FPFT (fusion press form technology), or by the twinsheet method. One particular aspect of the invention lies in an air duct, in particular from a foamed material, which is created by vacuum-formed, embossed, or FPFT-produced clamshells, or is produced by the twinsheet method, wherein the material weakening preferably is, or has been, respectively, incorporated during the production process of the clamshells. In principle, the component according to the invention can also be an injection-molded or blow-molded component, in particular having a foam structure.

In order for a potential for folding over or turning over to be produced, or for the material weakening to be produced, respectively, there are in particular the following possibilities:

In order for a potential for turning over to be produced, the main body can be embossed, or have been embossed (for example with round or wedge-shaped embossings). A hinge can be produced in particular herein.

Other geometric adaptations of the main body can be performed. For example, the main body can have a bellows which guarantees the turning-inside-out capability. The bellows creates a flexible moving element, optionally in addition to a further material weakening.

The main body can have punched features or cleanly punched-out features. Punched features or cleanly punched-out features can be incorporated in the main body.

It is possible in particular in the case of vacuum-formed, embossed, or FPFT-produced clamshells, for at least one insert part which is inserted into the main body to be provided in order for a turning-inside-out capability of the main body to be created. The at least one insert part can be at least partially covered.

In particular in the case of parts which are produced by the twinsheet method, turning over in the vacuum forming procedure can be achieved by driving in a core.

In principle, it is also conceivable for the connection element to be subsequently connected in a materially integral manner to the tubular main body, for example by welding and/or adhesively bonding the connection element, for example by welding and/or adhesively bonding a lip, in particular to a completed duct or air duct, respectively.

It is provided that the connection element is brought to engage with an engagement region or element of the further component in order for a form-fitting connection to be produced. The engagement region or element can be a depression or an elevation of the component, for example. For example, the connection element can engage in a clearance in the further component and/or engage behind a protrusion that is created on the further component. The connection element is preferably configured for creating a latching connection which is enabled in that the connection element is mounted on the tubular main body in an elastic-resilient manner. The connection element can thus pass through an engagement element of the other component, in particular in the axial direction of the tubular main body, and subsequently establish the engaged state by a radial rebound movement. The engagement region, or the engagement element, respectively, can be a latching element or a latching hook.

In order to achieve an enhanced sealing effect, it is preferable for the connection element in a longitudinal section (section along the longitudinal axis of the tubular main body) to have a curved and/or angular and/or inclined shape. On account thereof, improved wedging with an engagement element of the second component, for example a latching element or a latching hook, can take place. Moreover, improved sealing can be achieved by an acute-angled contour at the axial end of the connection element. In particular, the connection element, proceeding from a transition section at the transition between the main body and the connection element, extends in the direction of the opposite axial end of the main body, wherein an angular feature or curvature, respectively, that leads away from the main body in this direction is present.

The connection element preferably creates a lip seal for pressing radially against the second component. To this end, the connection element is preferably created from a flexible and/or elastic and/or restorable material. In particular, said connection element is capable of being pushed against the tubular main body counter to a tension force. A tension force thus preferably pushes the connection element away from the tubular main body. The seal lip is preferably created by an edge of the connection element that pushes radially against the second component.

It is preferable for the component to have a plurality of connection elements. In other words, a connection portion that is created by a plurality of connection elements can be present. The multiplicity of connection elements can be created in the form of circumferentially disposed and expediently circumferentially spaced apart lugs. A multiple-part portion that is turned over, or a multi-part connection element can be created. Part-regions along the circumference herein can also be reserved such that the individual (separate) connection elements are circumferentially spaced apart. The individual (separate) connection elements can be disposed in particular along the circumference of the component, or of the tubular main body, respectively. Non-destructive disassembling can be achieved on account of the plurality of connection elements, or notches and/or cut-outs and/or incisions and/or a material taper in the connection element/turned-over periphery. A congruence of the connection element (turned-over periphery) and of the counter element (engagement region, latching element, latching hook) can be disengaged by rotating the second component (assembly part) to be linked. Recesses in the connection element are particularly preferred in order for a latching to be unlocked.

The invention furthermore relates to an assembly of components, wherein a first component is configured according to the invention, and wherein the first component is connected and/or capable of being connected in a form-fitting manner to a second component.

The second component along at least part of the circumference thereof can have a latching element, in particular a latching cam, by way of which the connection element of the first component is connected and/or capable of being connected in a form-fitting manner. It can be provided in particular that the connection element engages behind the latching element of the second component. The latching element on the second component can be created, for example, by a partial material accumulation (creation of a bead, of a barb, etc.), by plasticization, and/or displacement.

In particular in order for two tubular air-guiding components to be connected, it is preferable for both components to be configured according to the invention. It is in particular provided herein that both components have a connection element that is created and/or capable of being created integrally with a tubular main body in order to be connected in a form-fitting manner to the respective other component. In particular, the two components can have connection regions or elements of substantially the same type, in particular connection regions or elements that are created by bending over a tubular initial body. Preferably, the connection element of a first component is created by bending over the tubular initial body outward, and the connection element of a second component is created by bending over the tubular main body inward. The connection elements of the two components are preferably interconnectable by creating a latching connection.

In a further preferred design embodiment, it is provided that the first component is releasably connected and/or capable of being releasably connected to the second component. Both components can therefore be disassembled. Disassembling can be performed in particular without releasing and/or removing a separate connection element, for example in that the components are first rotated in relation to one another and are then axially spaced apart from one another. To this end, clearances are preferably provided in the connection element, or in the turned-over periphery of the first component, as has already been explained in more detail above.

In a further aspect, the invention relates to a method for connecting components, wherein a first component has a tubular main body, in particular for guiding gas, preferably air, wherein a connection element is created integrally with the tubular main body by forming an axial end region of the tubular main body, and wherein a second component is connected in a form-fitting manner to the first component in that the connection element is brought to engage with an engagement element of the second component.

The invention overall also comprises the following aspects in particular:

The end region of an air guide is turned over. This defined turning over is enabled by an encircling or segment-type incision, or by a wall thickness reduction. The turned-over portion in the assembly process, conjointly with a push-fitted or plug-fitted adjacent component, then creates a form-fitting connection, in particular according to the barb principle. The assembly part (second component) to be linked is preferably provided with latching hooks. No separate adaptation parts are thus required for connecting the components. The air guide (the initial body) in the end region is weakened in an encircling or segment-type manner, for example by cutting, embossing, laser machining, or tapering. This can be performed during or after the production of the air guide. In the case of multiple-part air guides (for example, air guides having two clamshells), weakening is preferably performed only after welding or extruding, respectively. Turning over in a defined manner is enabled on account thereof.

The following features of the invention are to be highlighted in particular:

1. weakening (partial or encircling) in the end region of the air guide;
2. turning over the portion; and
3. fixing according to the barb principle.

The sequential or encircling cut can be produced in particular by cutting (encircling blade-cutting, kiss-cutting, laser cutting, laser using a counter sensor, cutter with anvil/device, pinching, manual work, serrated knife).

The cuts/incisions can be designed so as to be of dissimilar depth. Other possibilities for weakening are, for example, heat embossing (thermal depression by heat treatment/heat stress), a cut or cuts parallel with the actual end region of the component (trimming/punching). Furthermore, a material weakening can be provided by milled features, punched features, and cleanly punched features. In the case of multiple-shell welded air guides it is preferable for the incision region to be likewise trimmed. The plane of the weakening does not have to be perpendicular to the air guide axis.

As an alternative to turning over, it is also possible for the end region to be turned outward. In this case, it is preferable for the internal side of the air guide to have a trimmed feature or a taper, respectively.

The material thickness or wall thickness, respectively, of the tubular initial body is preferably between approximately 3 and 8 mm, in particular 4 to 6 mm, in particular approximately 5 mm. The cross section of the tubular main body is preferably between 20 and 100 mm. One exemplary embodiment provides a non-circular cross section having a first diameter of approx. 50 mm and a second diameter of approx. 70 mm.

The invention enables in particular the connection of air guides to one another or to further air-guiding components, in particular from the same material, without any additional connection elements and without additional sealing elements.

A simple, tight, and process-reliable plug-fit of an air guide (in particular from foam film, or a foamed air guide, or a blow-molded part, respectively) to a periphery (for example a vent, a distributor housing, an adapter frame, or a neighboring air guide) having a sufficiently firm fit is enabled by the invention.

The invention offers the following advantages in particular:

an integral air guide;

no additional adapters, or additional process steps, respectively;

a firm fit;

the production of the component according to the invention can be integrated in the manufacturing process of an air guide;

the connection of two components takes places according to a tested blocking principle (latching hook/barb);

simple fixing in relation to neighboring components is enabled;

the connection is very tight, in particular similar to a radial shaft seal ring.

There is no leakage worth mentioning. The tightness can be even enhanced by an inclined lip shape, or by an inclined connection element, respectively);

the invention can also be applied to non-concentric cross-sectional shapes;

the doubling of the wall thickness by turning over offers an enhanced peripheral rigidity.

### BRIEF DESCRIPTION OF THE DRAWINGS

The invention will be described in more detail hereunder by means of preferred exemplary embodiments which are illustrated in the appended schematic figures in which:

FIG. 1 shows method steps for producing an embodiment of a component according to the invention, in a perspective view and in a sectional view;

FIG. 2 shows a cross-sectional view of an embodiment of a component according to the invention;

FIG. 3 shows method steps for producing an embodiment of a component according to the invention, and a connection to a further component, in a sectional view;

FIG. 4 shows a design embodiment of an end region of an embodiment of a component according to the invention, including the interaction with a further component;

FIG. 5 shows a perspective view and a sectional view of a further preferred embodiment of the component according to the invention;

FIG. 6 shows two components that are interconnected according to the invention; and

FIG. 7 shows the connection of two embodiments of components to one another, in a sectional view.

Same elements, or elements of equivalent function, are identified by the same reference signs in all figures.

### DETAILED DESCRIPTION OF THE PREFERRED EMBODIMENTS

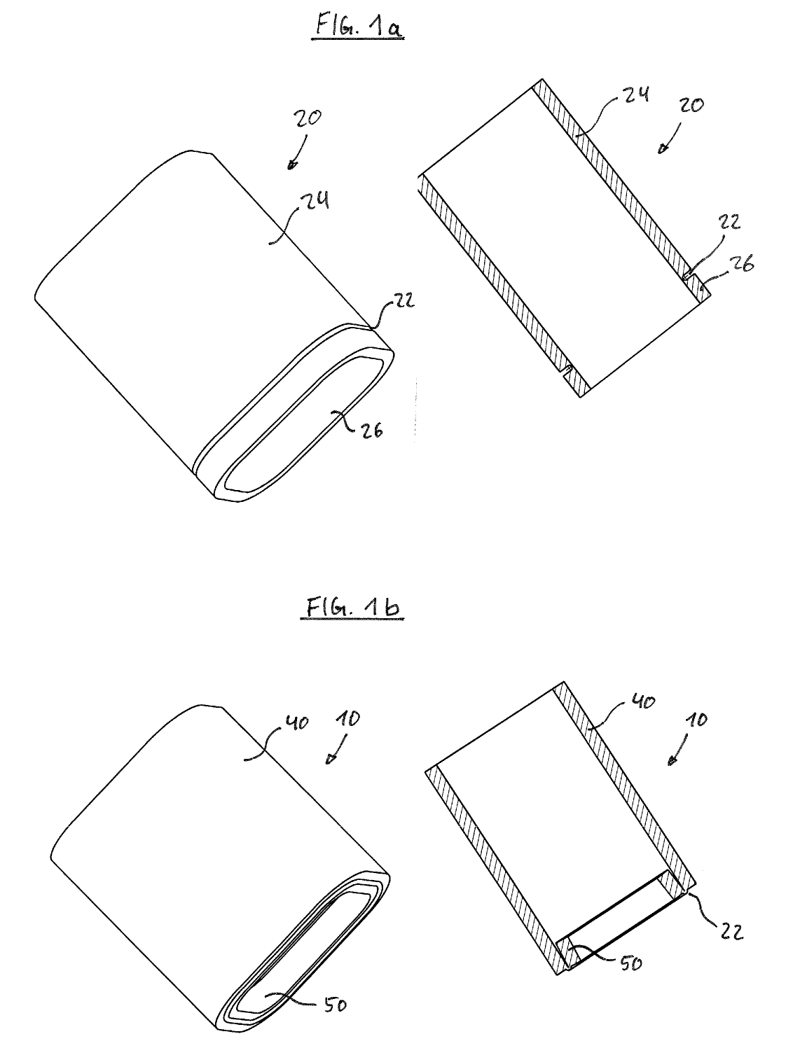

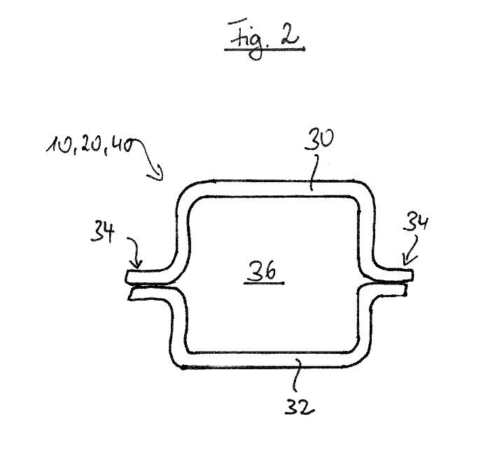

A production process of a component 10 according to the invention is illustrated in FIGS. 1a to 1b. FIG. 1a shows a tubular initial body 20 which presently is embodied as a foam material body, in particular from a foam film. The tubular body is preferably created from two clamshells 30, 32 (cf. FIG. 2) which are interconnected, in particular welded, along a welded periphery 34. A flow duct 36 is defined by the tubular initial body 20.

The initial body 20 at one axial end region has an encircling (continuous or interrupted) material weakening 22 which subdivides the tubular initial body 20 into a base portion 24 and a forming portion 26. For example, the material weakening 22 can be created by an encircling incision, for example in an external face of the initial body 20.

The forming portion 26 in the embodiment illustrated is folded over inward. However, folding over or folding over outward is also possible in principle. The welded periphery 34 is trimmed in the region of the forming portion 26. In other words, the welded periphery 34 in the region of the forming portion 26 can have been removed at least partially, preferably completely. Despite the welded periphery 34 present, this enables the turning over, or the folding over, respectively, of the forming portion 26 in the case of an initial body 20 that is created from two clamshells 30, 32.

FIG. 1b finally shows the completed component 10. The latter comprises a tubular main body 40 which is created from the base portion 24 of the tubular initial body 20, and a connection element 50 which is created by the turned-over forming portion 26 of the tubular initial body 20.

FIG. 2 shows a cross-sectional view of the base portion 24 of the tubular initial body 20, or a cross-sectional view of the tubular main body 40 of the component 10. It can be seen that the two clamshells 30, 32 each have an outwardly pointing protruding collar. The interconnected protruding collars create the welded periphery 34 which extends in the longitudinal direction (axial direction) of the initial body 20, or of the main body 40, respectively.

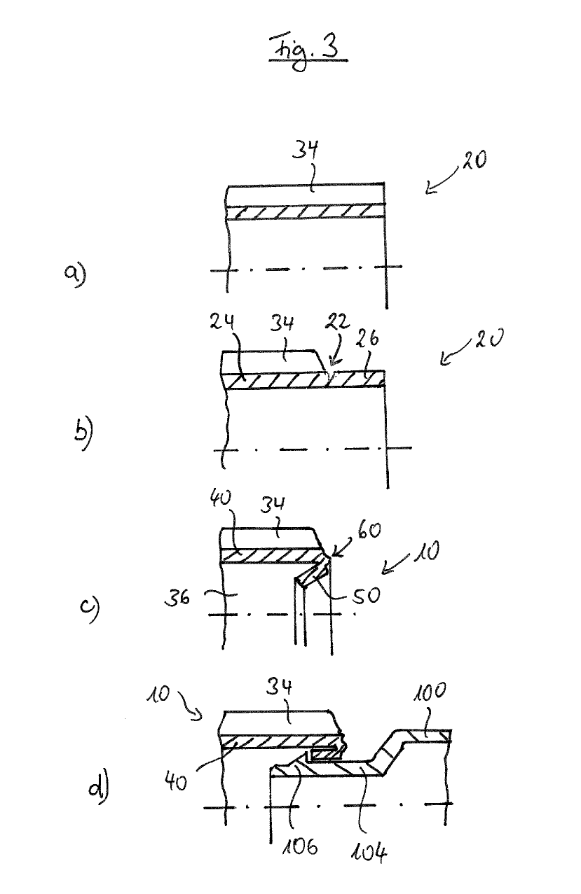

A component 10 according to the invention and the form-fitting connection thereof to a second component 100 are illustrated in FIG. 3. FIG. 3a shows a tubular initial body 20 which is created from two clamshells 30, 32 and has a welded periphery 34 that runs in the longitudinal direction of the initial body 20. In order for the component 10 according to the invention to be produced, the welded periphery 34 at an axial end region is at least largely removed or cut off, respectively. Moreover, a material weakening 22 is incorporated along a circumferential direction of the tubular initial body 20, for example by performing an incision in the tubular initial body 20. On account of the machining of the tubular initial body 20, in particular on account of the material weakening 22 and/or the severed end of the welded periphery 34, the tubular initial body 20 is subdivided into a base portion 24 and a forming portion 26.

In principle, the tubular initial body 20 can have an arbitrary cross-sectional shape, for example an angular, round, circular, elliptic, polygonal shape, or any combination thereof.

FIG. 3b corresponds substantially to a cross-sectional view of the component illustrated in FIG. 1a.

FIG. 3c in a cross-sectional view shows the folding over, or the turning over, respectively, of the forming portion 26, in a manner analogous to that of FIG. 1b. It can be seen in the cross-sectional view that a transition portion 60 along which the initial body 20, or the component 10, respectively, is angled is created between the base portion 24, or the tubular main body 40, respectively, and the forming portion 26, or the connection element 50, respectively. The transition portion 60 has a material thickness that is less than that of the adjacent portions, or of the tubular main body 40 and of the connection element 50, respectively, and creates an elastic articulation or hinge. FIG. 3c shows a completed component 10 according to the invention.

The form-fitting connection of the component 10 to a second component 100 is illustrated in FIG. 3d. The second component 100 comprises a tubular main body 104, at least one latching element 106 in the form of a protrusion being disposed on the external circumference of said tubular main body 104. The latching element 106 can be configured in a partially or completely encircling manner along the tubular main body 104. A form-fitting connection is achieved by plug-fitting the components 10, 100 into one another, wherein the connections element 50 during plug-fitting first passes the latching element 106 and subsequently engages behind the latter by way of a rebound movement. It is thus prevented that the form-fitting connection is released again. The connection element 50 along the transition portion 60 is resiliently mounted on the tubular main body 40 and in the radial direction pushes against the external circumference of the second component 100. A sealed state between the components 10, 100 is established in this way. A sealing face, or a sealing line, respectively, herein is created in particular by a distal edge of the connection element 50.

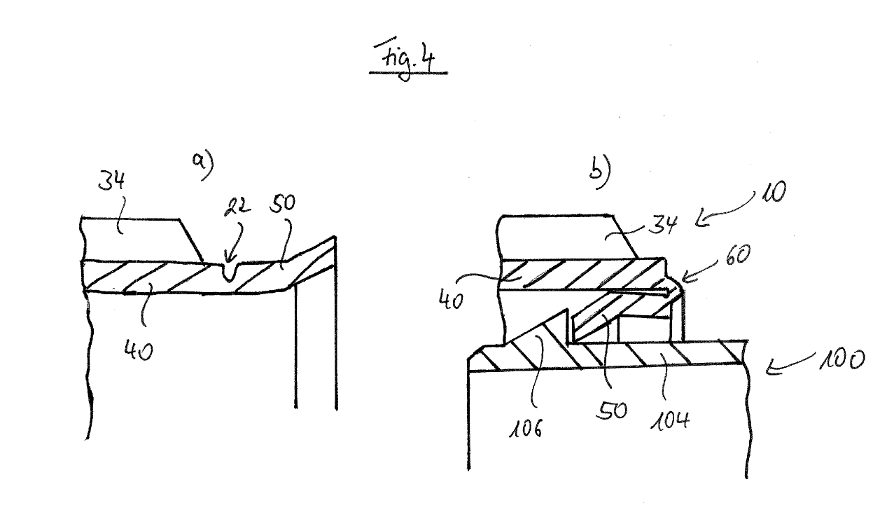

FIG. 4 shows an embodiment of a component 10 according to the invention, having a modified end region in order for sealing in relation to the second component 100 to be improved. FIG. 4a shows a modified initial body 20 in an illustration that corresponds to that of FIG. 3b. The illustration according to FIG. 4b corresponds substantially to a connected state of the components 10, 100 as is visualized in FIG. 3d. In order for an increased contact pressure of the connection element 50 on the second component 100 to be achieved, the connection element 50 as opposed to FIG. 3d is angled or bent in the longitudinal section. It can be seen in FIG. 4b that the connection element 50 is bent or angled from the transition portion 60 to the distal end in the direction of the second component 100. To this end, the forming portion 26 of the tubular initial body 20 is already bent or angled. Said forming portion 26 in the illustrated exemplary embodiment is designed as a widening. By turning over the bent or angled forming portion, respectively, a correspondingly bent or angular connection element 50, respectively, is created. The inclined lip seal shape offers improved wedging with the latching hook. An enhanced sealing effect is moreover achieved.

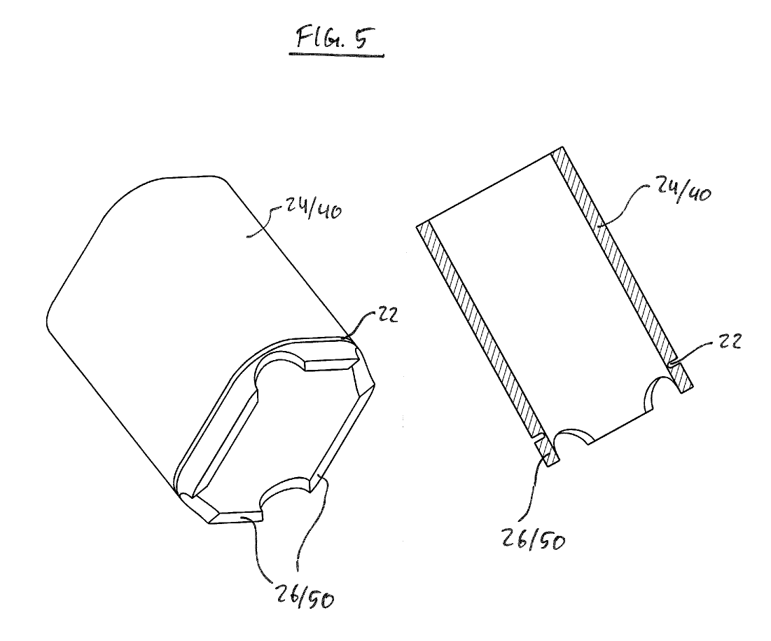

FIG. 5 shows a further design embodiment of a component 10 according to the invention, for connecting to a further component. As can be seen, the component 10 comprises a multiplicity of circumferentially disposed connection elements 50. The connection elements 50 are configured substantially in the form of lugs which by way of the material weakenings 22 are capable of being swung, or are swung, respectively, or are capable of being folded or are folded, respectively, outward, or as is illustrated, inward. The material weakenings 22 in one preferred embodiment are provided in such a manner that said material weaknesses do not extend across the entire circumferential extent of the lugs. The further component can likewise be created from a foam material or foam body, respectively, for example from a foam film. It is provided in particular that the components are created from or composed of the same material. The further component comprises a tubular main body and a latching element only along only part of the circumference of said main body, said latching element in a manner analogous to the production of the connection element 50 being created by bending over or turning over, respectively, an axial end region of the further component. The latching element is bent over outward such that said latching element can catch on the connection element 50 that is disposed on the internal side of the main body 40. To this end, the further component is plug-fitted into the component 10. However, in principle, a reversed arrangement is also possible, that is to say connection element 50 that is disposed on the external circumference of the tubular main body 40 and a latching element that is disposed on the internal circumference of the tubular main body.

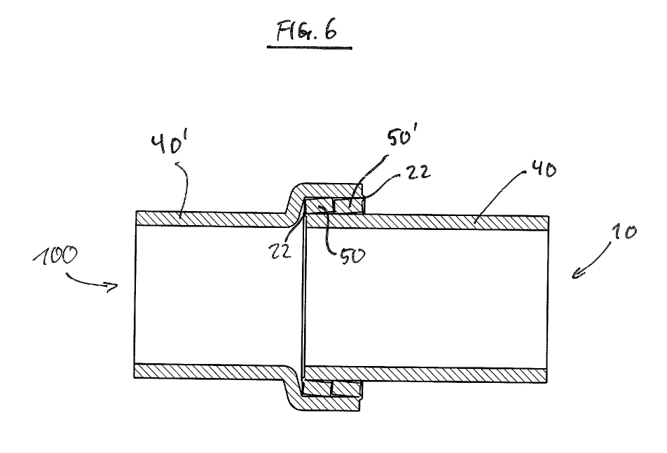

FIG. 6 shows a stable and leakage-tight connection of the components 10, 100, said connection being established by plug-fitting the components 10, 100 into one another.

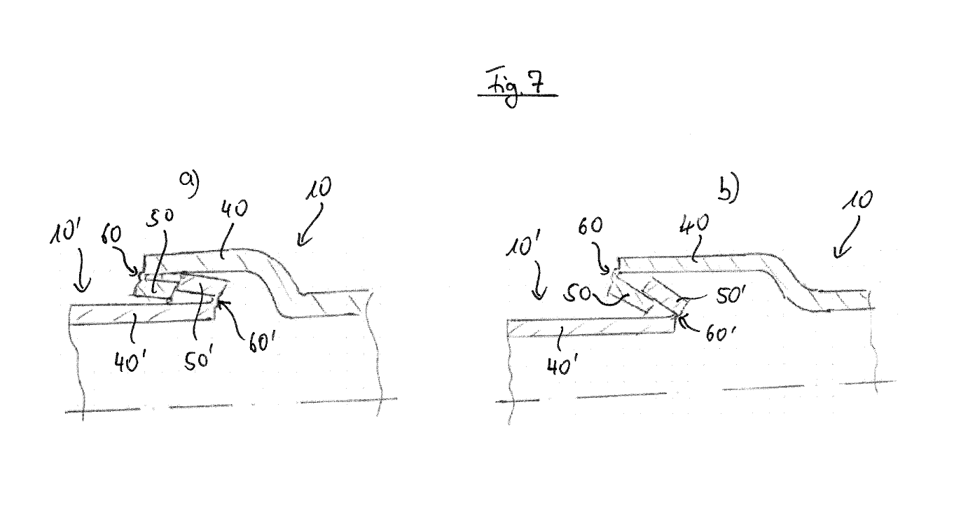

FIG. 7 shows the form-fitting connection of two components 10, 10′ according to the invention. In the case of a first component 10 according to the invention, the connection element 50 that is created integrally with the tubular main body 40 is disposed on an external side of the tubular main body 40. The component 10 has been created by turning over, or folding over, respectively, a forming portion 26 outward. A second component 10′ according to the invention corresponds substantially to FIG. 1 and has been created by turning over, or folding over, respectively, a forming portion 26 inward. The components 10, 10′ are plug-fittable into one another. The components 10, 10′ are interconnected in a form-fitting manner by the respective connection elements 50, 50′. The turned-over end regions (connection elements 50, 50′) herein block one another. The connection elements 50, 50′ herein can also be configured so as to corresponds to FIG. 4. Sealing elements are created on account of the connection elements 50, 50′. The lip seal shape causes an enhanced sealing effect.

The latching element 106 in FIG. 3 creates a partial holding lug. A plug-fitted air guide is produced by plug-fitting the components 10, 100 into one another. The respective end regions of the tubular main bodies 40 or initial bodies 30 herein are turned over inward or outward, respectively.

FIG. 7 shows the connection of two foam air guides or components 10, 10′, respectively, according to the invention. No separate adaptation parts, or adhesive bonding and/or welding, respectively, are required herein. In the case of a first air guide, the end region is turned outward, and in the case of a second air guide is turned inward. A form-fit is established upon joining of the two air guides, such that a firm fit is ensured. The connection elements 50, 50′ create lips which by virtue of the pretension seal positively in relation to the adjacent air guide wall. The end region of the air guide that is turned outward has the tendency to restore itself back to the initial shape. Targeted pretensioning of the lip (of the connection element) thus arises. In other words, there is the tendency for the radii region (transition portion 60) to elongate.

1.-15. (canceled)

16. An air duct of a heating, ventilation, and/or air-conditioning installation of a vehicle, comprising:
a tubular main body; and
a connection element configured to connect to a first component in a form-fitting manner, the connection element integral with the tubular main body;
wherein the tubular main body and the connection element are configured from an elastic material; and
wherein the connection element is configured from the tubular main body wherein the tubular main body in a basic state has an at least partially encircling material weakening along which the tubular main body is configured to form the connection element, and wherein the material weakening is includes at least one of a perforation, an interrupted cut, a serrated material thinning, and a thermally induced weakening.

17. The air duct as claimed in claim 16, wherein the connection element is configured from an axial end region of the tubular main body, and wherein the axial end region of the tubular main body extends more than 90° about the tubular main body.

18. The air duct as claimed in claim 17, where the axial end region of the tubular main body extends more than 135° about the tubular main body.

19. The air duct as claimed in claim 17, wherein the connection element is configured as at least one of as an internal circumferential face and an external circumferential face of the tubular main body.

20. The air duct as claimed in claim 19, wherein the tubular main body comprises a foamed material.

21. The air duct as claim in claim 20, wherein the tubular main body comprises a closed-cell foam material.

22. The air duct as claimed in claim 20, wherein, in the basic state, the ratio of the material thickness of the tubular main body to a spacing of the material weakening from the axial end of the tubular main body is less than 0.5.

23. The air duct as claimed in claim 22, wherein the ration of the material thickness of the tubular main body to the spacing of the material weakening from the axial end of the tubular main body is less than 0.3.

24. The air duct as claimed in claim 22, wherein the tubular main body is configured from at least two interconnected shells.

25. The air duct as claimed in claim 24, wherein the connection element in a longitudinal section has at least one of a curved, angular and inclined shape.

26. The air duct as claimed in claim 25, wherein the tubular air duct has a plurality of connection elements which are configured as circumferentially disposed and spaced apart lugs.

27. An assembly of components, wherein at least one air duct is configured as claimed in claim 1, and wherein the air duct is configured to connect to a second component in a form-fitting manner.

28. The assembly as claimed in claim 27, wherein the second component along at least part of a circumference of the second component has a latching element that connects the connection element in a form-fitting manner.

29. The assembly as claimed in claim 27, wherein the air duct is configured to be releasably connected to the second component.

30. The air duct as claimed in claim 16, wherein the connection element is configured as at least one of as an internal circumferential face and an external circumferential face of the tubular main body.

31. The air duct as claimed in claim 16, wherein the tubular main body comprises a foamed material.

32. The air duct as claim in claim 31, wherein the tubular main body comprises a closed-cell foam material.

33. The air duct as claimed in claim 16, wherein, in the basic state, the ratio of the material thickness of the tubular main body to a spacing of the material weakening from the axial end of the tubular main body is less than 0.5.

34. The air duct as claimed in claim 33, wherein the ration of the material thickness of the tubular main body to the spacing of the material weakening from the axial end of the tubular main body is less than 0.3.

35. The air duct as claimed in claim 16, wherein the tubular main body is configured from at least two interconnected shells.

36. The air duct as claimed in claim 16, wherein the connection element in a longitudinal section has at least one of a curved, angular and inclined shape.

37. The air duct as claimed in claim 16, wherein the tubular air duct has a plurality of connection elements which are configured as circumferentially disposed and spaced apart lugs.
